(19) United States
(12) Patent Application Publication
(10) Pub. No.: US 2016/0187045 A1
(43) Pub. Date: Jun. 30, 2016

(54) Cooler Chest Interior Insulation Device

(71) Applicant: Vern McGarry, Ladera Ranch, CA (US)

(72) Inventor: Vern McGarry, Ladera Ranch, CA (US)

(21) Appl. No.: 14/539,216

(22) Filed: Dec. 29, 2014

(51) Int. Cl. F25D 3/06; B23P 15/26

(52) U.S. Cl. CPC F25D 3/06; B23P 15/26

(57) ABSTRACT

An insulated cooler chest for carrying perishables and cooling medium such as ice is improved to provide an extended period during which low temperatures are maintained. A sheet of flexible, synthetic, closed cell foam insulation material is placed over the perishables and the cooling medium. The sheet is trimmed or cut oversized, compared to the size of the cavity of the cooler chest. The sheet is pressed downward in the cavity and against the perishables and cooling medium, substantially conforming to the upper surface thereof. As the insulating sheet is oversized, the edges of the insulating sheet compress and seal against the interior walls of the cooler cavity, thus sealing perishables and cooling medium from outside convection currents and conductive heat. Preferably, the insulating material is of closed cell polyvinyl chloride nitrile butadiene rubber foam (PVC/NBR), which possesses elastic, compressive and rebound properties. It is lightweight, washable, sufficiently flexible and can be easily trimmed or cut to size. The insulation material is preferably of sufficient thickness to seal against the interior cooler walls and not bow significantly.

### FIELD OF THE INVENTION

The present invention relates to a flexible sheet of insulation material placed in a portable cooler cavity for improving the insulation of perishables and the effectiveness of the cooling medium placed inside the cooler.

### BACKGROUND ART

Insulation of storage containers has resulted in numerous prior art inventions. Most of these are directed to containers of constant geometry. That is; floor, walls and a top are provided, defining an outer boundary, which remains constant with respect to the constituent boundary members regardless of the volume of the contents. Generally, material having superior insulation characteristics is incorporated into one or more boundary members.

Prior art has described shelving, grid or rack devices placed with a cooler chest to keep food items above the cooling medium or to keep food items dry.

Prior art has described an insulated multi-layered blanket laid atop the food items and cooling medium within the cavity of a cooler chest.

U.S. Pat. No. 5,351,494, issued to Roger L. Jensen; Joanne E. Jensen on Oct. 4, 1994, describes a cooler chest insulative blanket which is intended to provide an extended period of time during which low temperatures are maintained within the cooler. A sheet of flexible, synthetic insulation material is placed over the perishables and cooling medium. The insulative material is described as being able to be folded into at least three thicknesses and may be tucked down and around the perishables in the cooler, thus improving the insulative characteristics of the cooler.

This patent expired on Oct. 4, 2006 for failure to pay the 12^{th} year maintenance fee required by the United States Patent and Trademark Office.

U.S. Pat. No. 5,154,309 issued to Henry Wischusen III et al. On Oct. 13, 1992, describes an insulated shipping container which is intended to preserve perishables, such as seafood, with a cooling medium, such as ice. One element of the container is a U-shaped insulating blanket made from several strata of insulating material. This blanket, when the container is assembled, is sandwiched between inner and outer walls of other componants and improves insulation by preventing transfer of heat by conduction and convection. It should be noted that this blanket always bears against or is located immediately beneath a top wall member of the container.

U.S. Pat. No. 5,105,970, issued to Thomas G. Malone et al. on Apr. 21, 1992 describes a shipping container retrofitted with insulation blankets that are attachable to the shipping container walls creating an insulating layer of air. The insulating member is made from a plural ply, including a ply of polyethylene foam. The insulating member occupies a constant location within in the shipping container.

U.S. Pat. No. 5,052,184, issued to Paul L. Jarvis on Oct. 1, 1991 describes a cooler chest grid supported by legs. The top of the device is a screened grid upon which items to be cooled and kept separate from the cooling medium, such as ice, are placed. Doors in the elevated grid are provided to access sealed beverage containers storable under the screened grid. The grid may also be constructed of materials which can be pre-cooled to aid the cooling effect with a cooler chest.

U.S. Pat. No. 5,052,185, issued to William Spahr on Oct. 1, 1991 describes an ice box rack designed to keep the stored food and other items dry, while slowing the melting of the ice. The planar bottom surface of the rack is designed to place uniform pressure on granular, chopped or cubed ice, compressing it. Compression of the ice causes the ice to melt less quickly, thereby prolonging the cooling process. The device is designed with offset slats on an upper and lower surface with a supporting framework between the upper and lower offset slats. Also included on the lower surface slats are open drain ports. The stated design of this device is to slow the rate of ice melting through compaction.

U.S. Pat. No. 5,022,101, issued to Jeffrey E. Gosselin et al. on Jun. 11, 1991 illustrates a thermal cover placed over a spa. The cover is formed by three ply lamination, including a plastic film. Another cover is seen in U.S. Pat. No. 4,972,529, issued to Sydney K. Wolfson, Jr., on Nov. 27, 1990. This cover is made from, preferably, two plies of a plastic, such as polypropylene.

U.S. Pat. No. 4,759,467, issued to Thomas R. Byrne on Jul. 26, 1988 discloses a liner for a cooler which prevents water originating from melted ice from comingling with perishables stored in the cooler. The liner has a floor, lateral walls, and an open top. Preferred consitute materials include extruded film of polyvinyl chloride, polyethylene and the like.

A thermal insulating blanket for sealing an opening in a building is shown in U.S. Pat. No. 4,675,225, issued to William P. Cutler on Jan. 23, 1987. The blanket described therein is fiber filled and compressable, the interior communicating with the exterior, so that the fiber filling can be compressed and expanded.

The use of polyurethane in a blanket is seen in U.S. Pat. No. 4,944,844 issued to Joseph J. Marchinko on Jul. 31, 1990. The polyurethane is reinforced synthetic fibers, and it not employed for insulation purposes.

None of the above inventions and patents, taken either singly or in combination, is seen to describe instant invention as claimed.

### SUMMARY OF INVENTION

The present invention is directed more specifically to portable coolers, typically employed to store and transport perishables at reduced temperatures. Such a cooler typically includes insulated floor, walls and a cover, defining a single open cavity therein. The cover may or may not be hinged to the container and may or may not be insulated. The cavity holds both perishables, such as food, and a cold substance for absorbing heat, which will be referred to as a cooling medium hereinafter. Examples of cooling media include ice and packaged commercial products intended to go through a freezing and melting cycle with each use. Perishables are variable in nature, having different sizes, shapes, weights, packaging, and other characteristics. They are generally placed in an organized fashion within the cooler cavity and the cooling medium is advantageously placed therearound. It is frequently the case that the cooler cavity is only partly filled and a significant portion of the volume of the cooler cavity is unused. Air circulating in this unused portion introduces heat to the contents by convection and conduction. Even when the cooler cavity is filled, unacceptable heating may occur, particularly if the cover is not insulated.

A significant area of improvement of a cooler exists in preventing these heat gains.

As illustrated by the prior art, increasingly complex, sophisticated and expensive construction may be attempted in accomplishing this objective. However, it is the purpose of the present invention to provide the benefits listed above in a superior fashion and in the least complex and in the most inexpensive way.

To this end, the present invention includes a flexible sheet of a water resistant, readily available material, which is advantageously arranged within the cooler cavity so as to prolong the period during which low temperatures are maintained. The material is preferably a bulk material of superior insulating characteristics, such as closed cell polyvinyl chloride nitrile butadiene rubber foam, also known as PVC/NBR. This material is readily cut or otherwise trimmed to desired dimensions, is water resistant and can be washed. It is therefore very practical for the typical consumer.

This material has the characteristics of compressability and reboundability. It is purchased in bulk lots, cut as required and placed in the cooler cavity.

Accordingly, it is the principle objective of the invention to improve on the insulation characteristics of a conventional portable cooler.

Another objective of the invention is to minimize the volume of the main cooling chamber, leaving minimal air around the contents therein.

An additional objective of the invention is to seal the interior sides and corners of a portable cooler to minimize heat gain within the sealed portion of the cooler through convection and/or conduction.

An additional objective of the invention is to maximize the insulating value of a sheet of insulating material.

Another objective of the invention is to provide a closed cell, water resistant, foam insulation material

Another objective of the invention is to provide an insulation material composed of closed cell polyvinyl chloride nitrile butadiene rubber foam, also known as PVC/NBR. This insulative material is elastic and has the characteristics of compressability and reboundability.

Another object of the present invention is to provide improved elements and arrangements thereof in an apparatus for the purposes described which is inexpensive, dependable and fully effective in accomplishing its intended purpose. These and other objects of the present invention will become readily apparent upon further review of the following specifications and drawings.

### BRIEF DESCRIPTION OF DRAWINGS

FIG. 1 is a perspective view of the invention

FIG. 2 is a diagrammatic, side cross sectional view of the invention FIG. 3 is a diagrammatic, cut-away, side cross sectional view of the invention,

illustrating the invention sealing an interior wall of a cooler chest.

### DESCRIPTION OF EMBODIMENTS

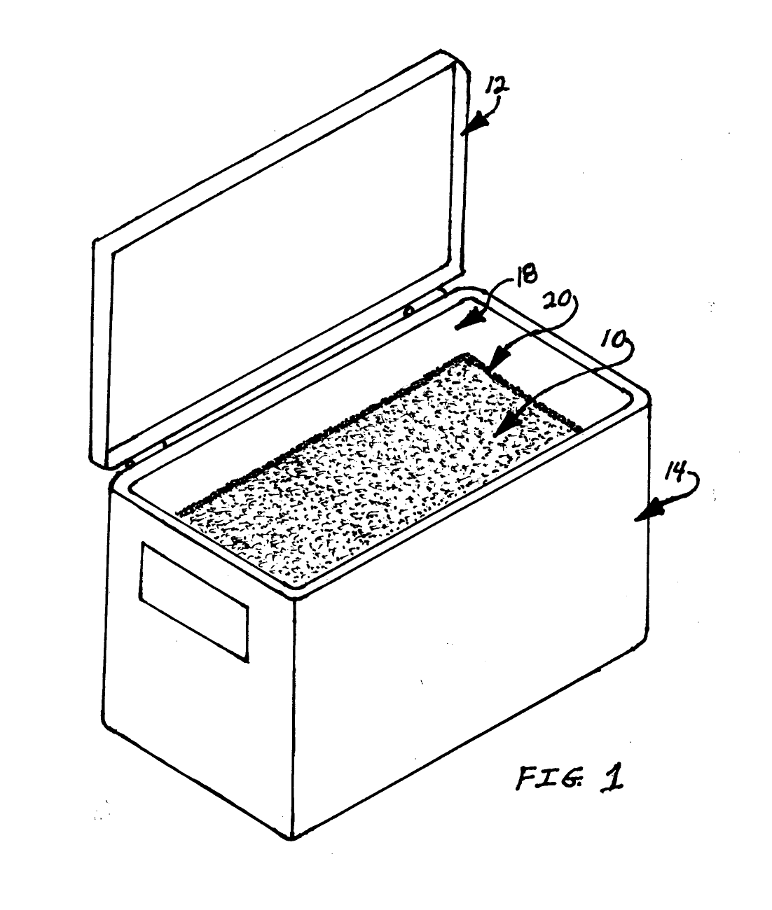

Referring to FIG. 1 of the drawings a cooler chest 14 is shown. There is also a cavity 18 within the cooler which provides an insulated chamber intended to hold and insulate contents. A sheet of insulating material 10 is placed within the cavity 18 of the cooler chest 14. A preferred insulating material is closed cell polyvinyl chloride nitrile butadiene rubber foam (PVC/NBR). Insulating sheet 10 is slightly oversized in width and length compared to the width and length of the cooler cavity 18. This slight oversizing of insulating sheet 10 causes the edges of the insulating sheet 10 to compress 20 and bulge slightly as insulating sheet 10 conforms to the interior walls of the cooler cavity 18, thus sealing the lower portion of the cooler cavity 18 from the now upper portion of the cooler cavity 18.

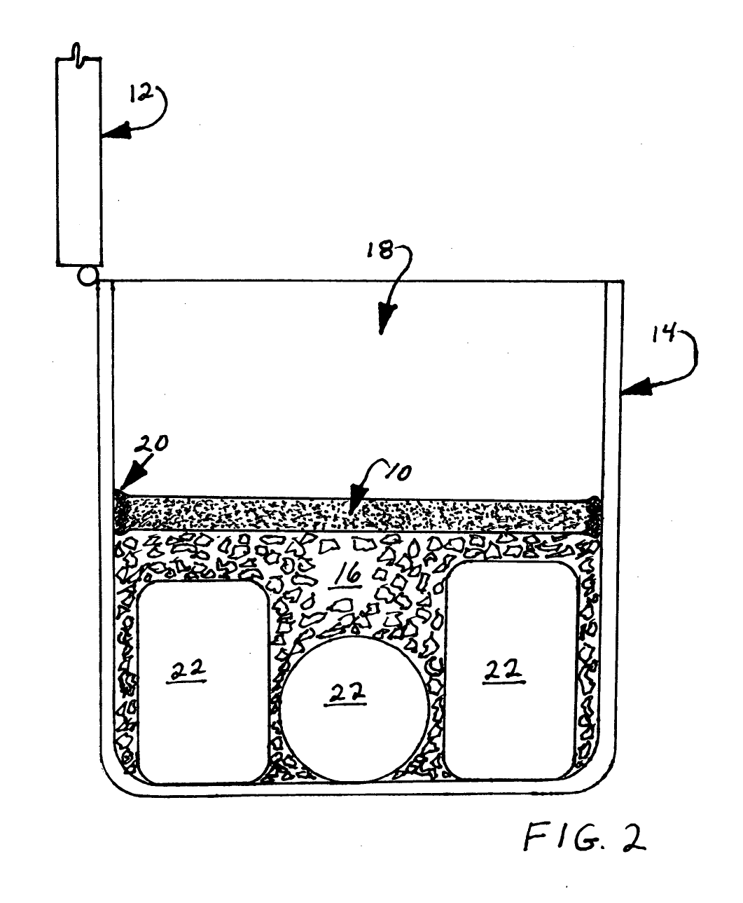

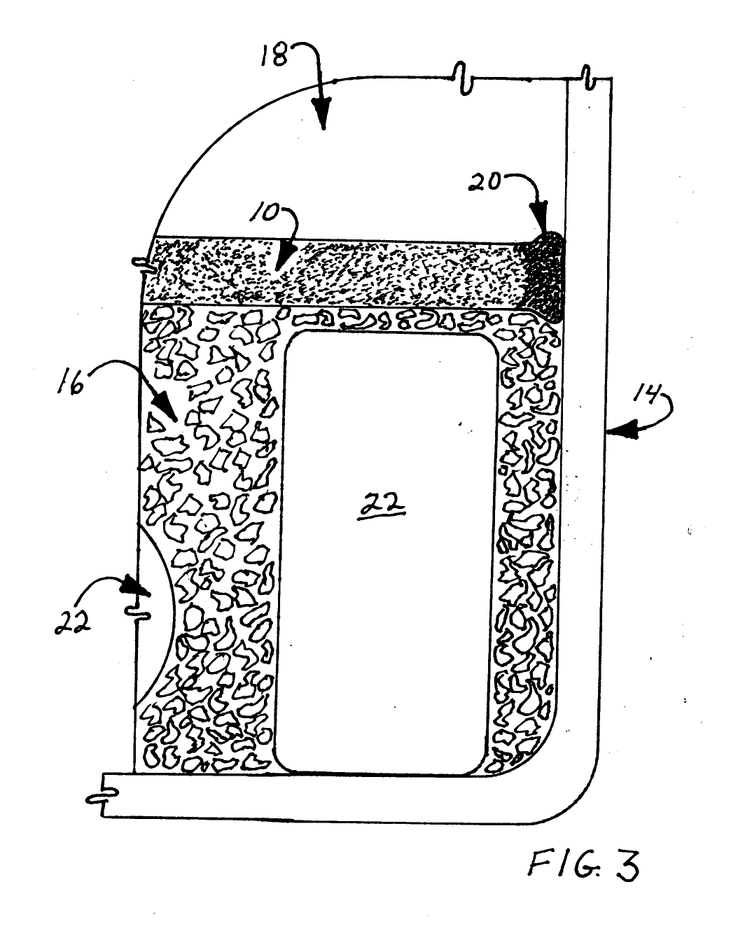

Referencing FIG. 2, a side cross sectional view of the invention, a cooler 14 is shown partially packed with perishables 22 and a cooling medium 16. Within the cavity 18 of the cooler 14 insulating sheet 10 is pressed down against the perishables 22 and the cooling medium 16. Insulative sheet 10 is composed of an elastic closed cell foam, such as PVC/NBR, and trimmed slightly oversized when compared to the dimensions of the cooler cavity 18. The oversizing of insulating sheet 10 causes its edges to compress and bulge as they contact and conform to the shape of the interior walls of cooler chest 14. The bulging and subsequent rebounding of insulating sheet 10 seal the perishables 22 and cooling medium 16 from outside heat.

A consequence of the placement of insulating sheet 10 is that the volume of the zone of air which would otherwise surround perishables 22 and cooling medium 16 is reduced.

Referring to FIG. 3, a cutaway cross sectional view of the cooler chest 14, insulating sheet 10 is seen pressing against the interior wall of cooler chest 14. The insulating sheet is cut, or trimmed, slightly oversized compared to the interior dimensions of the cooler chest 14. FIG. 3 demonstrates the sealing properties of insulating sheet 10 as it bulges slightly while conforming to the interior walls of the cooler cavity 18, creating a compression seal.

Cooler chests 14 are made in many different sizes, shapes and configurations. Several sizes of insulating sheet 10 are to be made. Each insulating sheet 10 is to be trimmed to a size slightly larger than the length and width measurements of the cooler chest cavity 18 that it is intended for.

A preferable manner of maximizing the insulation value of insulating sheet 10 is to use a thickness of insulating sheet 10 that is sufficient to allow compression sealing 20 at the edges of insulating sheet 10, but does not allow significant bowing of insulative sheet 10.

The main steps in using insulative sheet 10 are trimming or cutting insulating sheet 10 to a size slightly larger than the interior width and length of the cooler chest cavity 18, setting the insulating sheet 10 within the cooler chest cavity 18 and against the interior walls of cooler chest cavity 18.

It is to be understood that the present invention is not limited to the sole embodiment described above, but encompasses any and all embodiments within the scope of the following claims.

Having thus described my invention, I claim:

1. A method of insulating a portion of a cooler chest packed with perishables and cooling medium, comprising the steps of:
a) Placing a flexible sheet of synthetic, closed cell foam, thermal insulative material over the perishables and cooling medium, below the cover of the cooler chest; and
b) configuring the flexible insulating sheet to cover substantially the upper surface collectively defined by the perishables and cooling medium.

2. The method of claim 1, wherein step a) comprises: the step of placing a flexible sheet of synthetic, closed cell, thermal insulation over the perishables and cooling medium and below the cover of the cooler.

3. The method of claim 1, wherein step a) comprises: The step of placing a sheet of closed cell polyvinyl chloride nitrile butadiene rubber foam (PVC/NBR) over the perishables and below the cover of the cooler chest.

4. The method of claim 1, further including the step of: cutting or trimming the flexible insulating sheet to correspond, approximately, to a dimension slightly larger than the interior dimensions of the cooler cavity.

5. The method of claim 1, including the step of: placing the sides of the flexible insulating sheet against the sides of the interior walls of the cooler chest cavity, thereby sealing the perishables and cooling medium from outside air and heat sources.

6. A cooler chest having improved insulation for perishables and cooling medium placed therein, said cooler including an insulated floor, insulated walls and a cover, defining therein as insulated cavity; and there being a sheet of flexible closed cell thermal insulation foam disposed above the perishables in close proximity thereto and below said cover, said sheet further being configured to be slightly larger than the interior of said cooler chest cavity; and said sheet further being configured to cover substantially the upper surface collectively defined by the perishables and cooling medium.

7. Said synthetic, thermal insulation, closed cell foam, comprising polyvinyl chloride nitrile butadiene rubber (PVC/NBR).

8. The cooler chest cavity having a cross sectional area of predetermined configuration, said insulation sheet being pre-formed to a size slightly larger than said cross sectional area.
